(19) United States
(12) Patent Application Publication
(10) Pub. No.: US 2010/0214697 A1
(43) Pub. Date: Aug. 26, 2010

(54) SUSPENSION DESIGN FOR HIGH SHOCK PERFORMANCE SOLDERING BALL BONDING

(76) Inventors: Minggao Yao, Dongguan (CN); Sun Yu, Dongguan (CN); Lin Guo, Dongguan (CN)

Correspondence Address: NIXON & VANDERHYE, PC, 901 NORTH GLEBE ROAD, 11TH FLOOR, ARLINGTON, VA, 22203, US

(21) Appl. No.: 12/452,488

(22) PCT Filed: Jul. 5, 2007
(86) PCT No.: PCT/CN2007/002075

§ 371 Date: Apr. 15, 2010

(51) Int. Cl. G11B 5/48

(52) U.S. Cl. 360/246.2; G9B/5.147

(57) ABSTRACT

Aspects of the present invention include a system and method for improving the reliability performance of hard disk drives by routing the traces connected to the slider from the trailing edge to the leading edge and having a portion of the traces being under the magnetic slider. Aspects of the present invention can also include routing the traces in a manner that lessens the stress experienced during vibration or shock events.

### FIELD OF THE INVENTION

The present invention relates to an information storage device such as a disk drive unit. More specifically, the present invention relates to a method and system of design for a suspension for a high shock performance soldering ball bonding in a disk drive.

### BACKGROUND

Disk drives are commonly used in the computer and related arts for storing digital information, i.e. data. FIG. 1A provides an illustration of a typical hard drive as known in the art. The drive consists of a base 101 that houses a series of rotatable magnetic disks 102. A slider 104 containing a read/write element is connected to a head gimbal assembly (HGA) 105. A drive arm 106 uses a voice-coil-motor (VCM) to position the read/write element of the slider 104 over a particular track on the rotatable disk 102 so that data can be read and written. The data being read from and written to the disks 102 is transmitted to and from the read/write element through wiring such as a cable strap 107. FIG. 1B provides an alternative view of the rotating disks 102a-b and illustrates how multiple disks 102a-b can be layered on top of one another with enough space to allow the HGA to access the disks' 102a-b tracks.

FIG. 2 shows a typical HGA as is currently known in the art. The HGA consists of a flexure 201 bonded to a load beam 202. A slider 203 with a read/write element (not shown) is connected to the flexure 201. The flexure has a number of traces 205, each with a trace pad 206a-d at its end. The traces 205 and trace pads 206a-d are designed for transmitting signals to and from the read/write element on the slider 203. The slider 203 has a number of conductive bonding pads 204a-d at its trailing edge for connecting to the trace pads 206a-d. In the example of FIG. 2, the traces 205 run from behind the leading edge of the slider 203, around its sides, and bend at the trailing edge of the slider 203 in order to locate the trace pads 206a-d adjacent to the conductive bonding pads 204a-d which are located at the leading edge of the slider 203.

In the art today, a commonly used method for bonding the slider's conduction pads 204a-d to the trace pads 206a-d is soldering ball bonding (SBB). Referring to FIG. 3A, a typical ball bonding structure is shown. A conductive material, such as a solder ball 310, is deposited between the bonding pad 304 of the slider 303 and the trace pad 306. When the soldering ball 310 is melted and cooled, the bonding pad 304 of the slider 303 and the trace pad 306 are electrically coupled to one another.

This method of bonding, however, can be very delicate, and the SBB joint can have a susceptibility to cracking, especially when it experiences a sudden shock or vibration happens or change in operating conditions, such as temperature or humidity. FIG. 3B shows the ball bonding after it has been melted and cooled. The solder no longer resembles a sphere, but instead has a sloped shape, with traces extending out past the end 311 of the solder. The area at the end of the SBB joint 311 can be a weak point highly susceptible to cracking.

This susceptibility to cracking lessens the reliability of hard disk drives. In view of this, there exists in the art a need for an improved method and apparatus for reliably coupling a slider to electrical traces.

### SUMMARY OF THE INVENTION

Aspects of the present invention include a suspension design method for improving the reliability performance of HDDs, particularly the shock performance of the SBB joints. Aspects of the present invention can include routing the traces from the leading edge side of the slider and having at least a portion of the traces being under the magnetic slider. Aspects of the present invention can also include routing the traces in a manner that lessens the stress experienced during vibration or shock events. Aspects of the present invention can include routing the traces from the leading edge side of the slider and having at least a portion of the traces being under the magnetic slider to achieve improved performance and improved reliability.

### BRIEF DESCRIPTION OF THF DRAWINGS

FIGS. 1A and 1B show hard disk drives typical in the art.

FIG. 2 shows an HGA typical in the art.

FIGS. 3A and 3 B show a solder ball bonding structure as used in aspects of the present invention.

FIGS. 4A and 4B show an HGA embodying aspects of the present invention.

FIG. 5 shows shock test data for a prior art HDD and an HDD embodying aspects of the present invention.

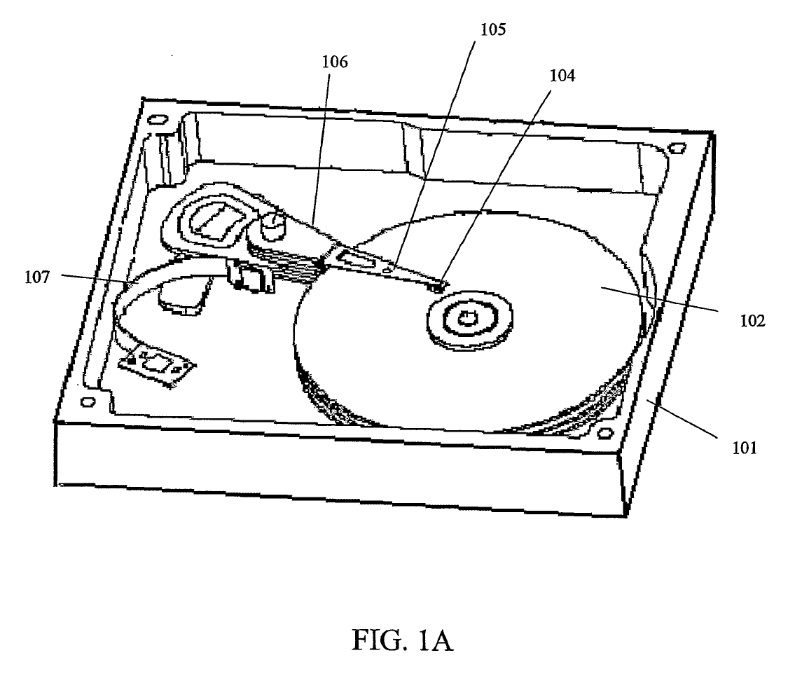

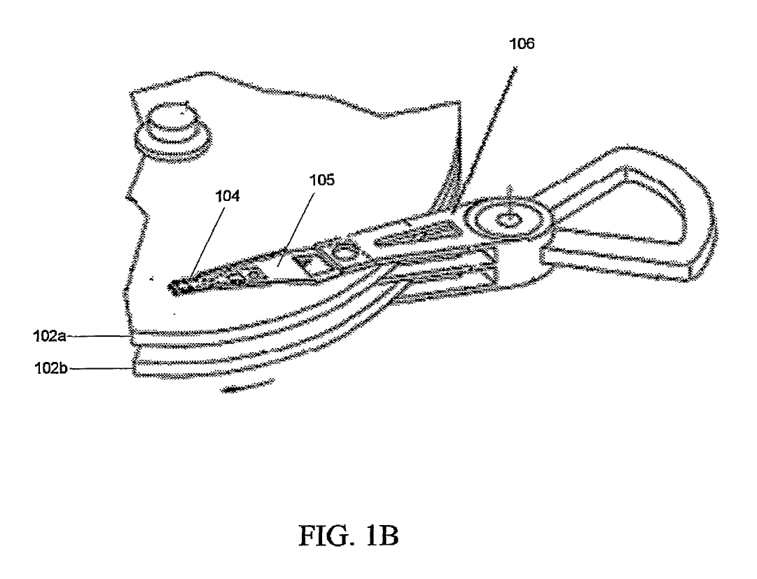

### DETAILED DESCRIPTION

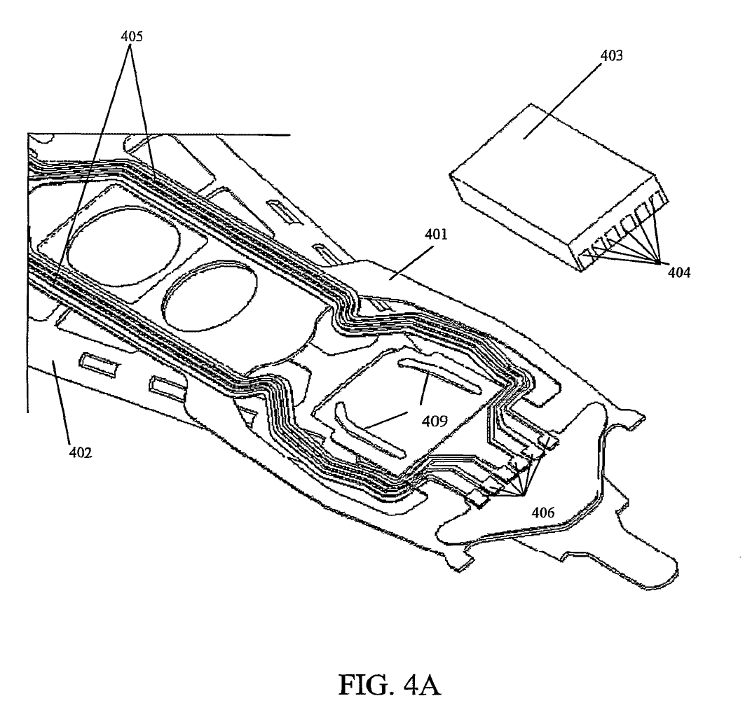

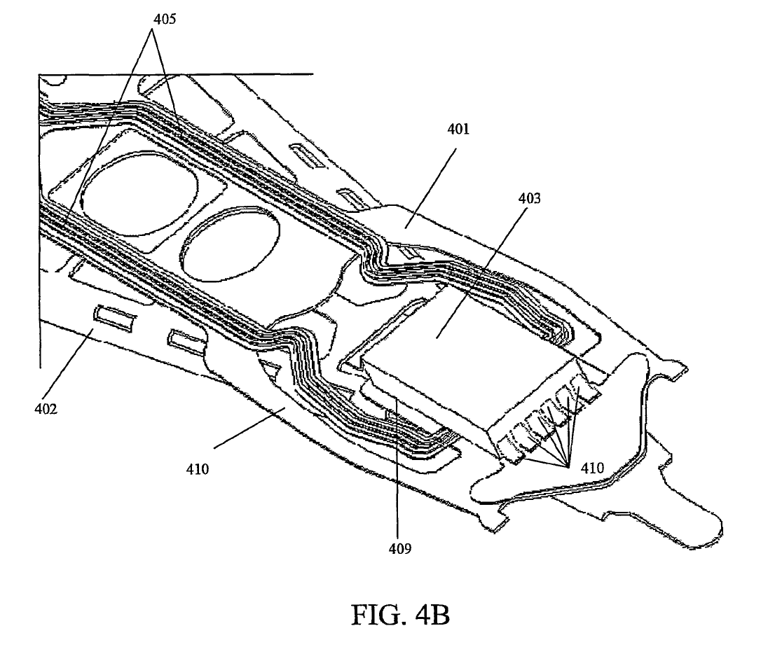

FIGS. 4A and 4B show an HGA embodying aspects of the present invention. FIG. 4A shows the HGA with the flexure 401 of the suspension and slider 403 detached from one another. FIG. 4B shows the HGA with the slider 403 mounted to the flexure 401 of the suspension and the slider 403 is soldered to the suspension flexure 401.

A flexure 401 can be mounted to a load beam 402 using various methods such as welding. Multiple traces 405 can be attached to the flexure 401 using various methods, such as chemical platting and etching. The traces 405 can consist of a base polymer layer, a conductive layer (such as copper, nickel, or gold) and a polymer cover layer. During the manufacturing process, the layers can be laminated to the flexure.

Each trace 405 can have a trace pad 406 at its end for making an electrical connection between trace 405 and the read/write transducer on the slider 403. The conduction pads 404 of the slider can be bonded to the trace pads 406 through solder ball bonding, which involves melting a solder ball on the conduction pads 404 and trace pads 406 and cooling it to create an SBB joint 410.

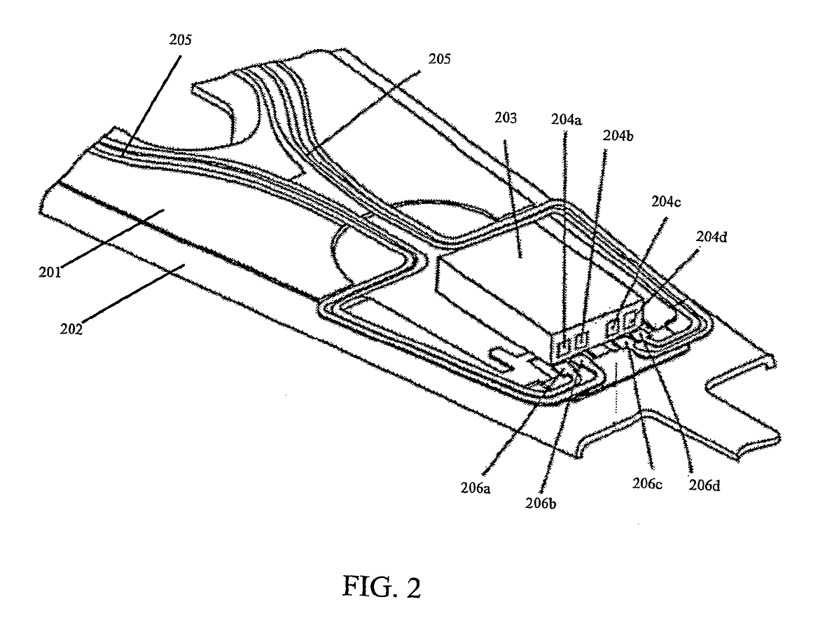

Unlike the prior art described in FIG. 2, aspects of the present invention include routing the traces 405 to the conduction pads 404 of the slider 403 from the leading edge side (i.e. the direction going from the leading edge to the trailing edge) rather than routing the traces 405 around the slider 403 towards the leading edge side (i.e. the direction going from the trailing edge to the leading edge). Aspects of the present invention can also include having a portion of the trace 405 being routed under the slider 403.

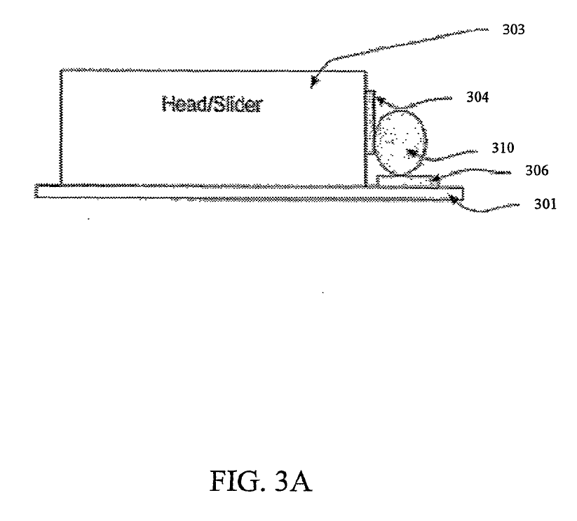

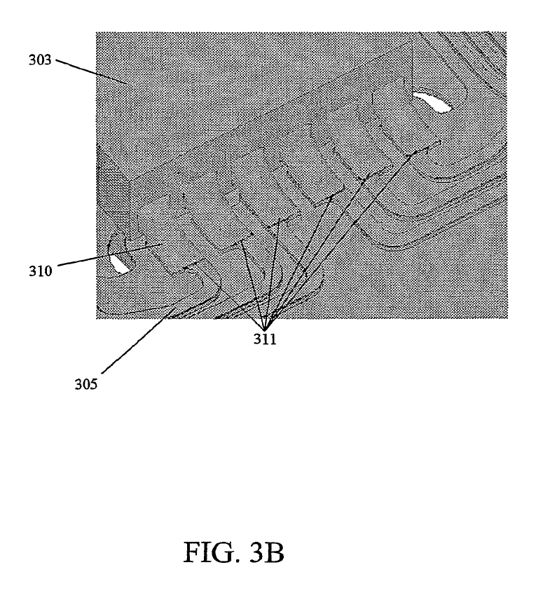

In FIG. 3B, the non-free end of the trace pad 306 (i.e. the end connecting to the trace 305) is located at the weakest point 311 of the SBB joint. In the system of FIG. 4B which embodies aspects of the present invention, the connection between the trace and trace pad is under the slider 403, and the free end of the trace pad is located at the end of sloped shaped solder structure 410.

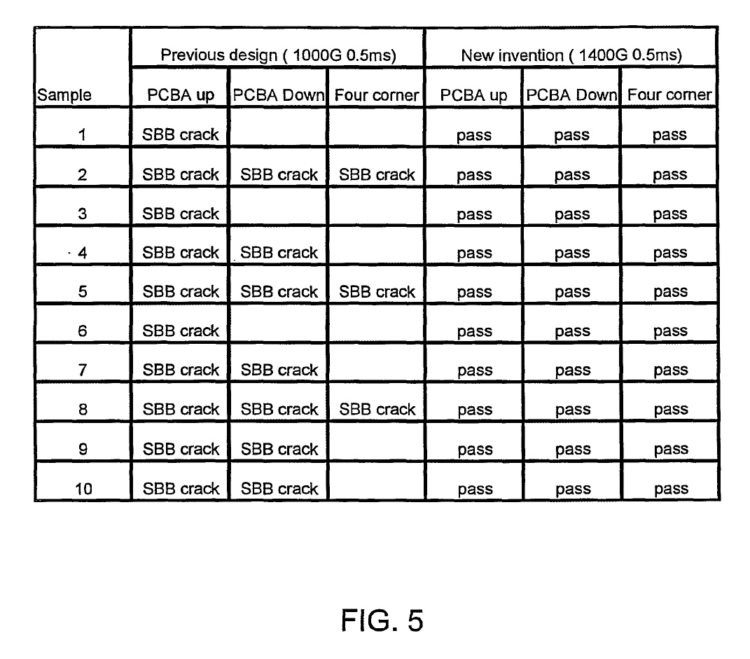

FIG. 5 shows testing data for a prior art 1.8-inch HDD and a 1.8-inch HDD embodying aspects of the present invention. 10 samples were tested under three different conditions in a standard shock testing system. Each sample was set in a printing circuit board assembly (PCBA) up direction, a PCBA down direction, and a four corner (four side) direction. The data shows all the samples of the previous design had SBB crack issues in the PCBA up direction when the HDD experienced a mechanical shock of 1000 G for a 0.5 ms shock duration. Most had crack issues in the PCBA down direction, and some had crack issues when tested in the four corner direction. The 10 samples embodying aspects of the present invention all passed tests for a 1400 G mechanical shock for a duration of 0.5 ms in all three conditions.

The previous description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

What is claimed is:

1. A system comprising:
a suspension;
a slider configured to be attached to said suspension;
a flexure,
a trace configured to be attached to said flexure, a portion of said trace to be located between said slider and said suspension;
a trace pad for said trace configured to be bonded to a conduction pad for said slider.

2. The system of claim 1, wherein said trace pad is to be bonded to said slider pad by soldering ball bonding or gold ball bonding

3. The system of claim 1, wherein said trace is at least partially laminated from a leading edge of the slider to a trailing edge.

4. The system of claim 1, wherein said trace has an electrical pad at its free end, said electrical pad extending out from said trace.

5. A hard disk drive comprising:
a series of rotatable disks;
a head gimbal assembly comprising:
a suspension;
a slider configured to be attached to said suspension;
a flexure;
a trace configured to be attached to said flexure, a portion of said trace to be located between said slider and said suspension;
a trace pad for said trace configured to be bonded to a conduction pad for said slider.

6. The hard disk drive of claim 5, wherein said trace pad is to be bonded to said slider pad by soldering ball bonding or gold ball bonding

7. The hard disk drive of claim 5, wherein said trace is at least partially laminated from a leading edge of the slider to a trailing edge.

8. The hard disk drive of claim 5, wherein said trace has an electrical pad at its free end, said electrical pad extending out from said trace.

9. A method comprising:
laminating a suspension;
attaching a slider to said suspension;
attaching a trace to a flexure, a portion of said trace to be located between said slider and said suspension;
bonding a conduction pad of said slider to a trace pad of said trace.

10. The method of claim 9, wherein said bonding is soldering ball bonding or gold ball bonding.

11. The method of claim 9 wherein said trace connects to said trace pad at the trailing edge side of the trace pad.
